(19) United States
(12) Patent Application Publication
(10) Pub. No.: US 2007/0288634 A1
(43) Pub. Date: Dec. 13, 2007

(54) Computer readable recording medium storing control program, communication system and computer data signal embedded in carrier wave

(75) Inventor: Hisashi Nakatsuyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/601,825

(22) Filed: Nov. 20, 2006

(30) Foreign Application Priority Data
Jun. 12, 2006 (JP) 2006-162261

(51) Int. Cl. G06F 15/173

(52) U.S. Cl. 709/225; 709/226

(57) ABSTRACT

A computer readable recording medium storing a control program causing a computer arranged on a same terminal as a resource to execute a process for authentication performed at the time of accessing to the resource, the process including: determining whether or not a request from a browser to the resource presents information indicating that the authentication has been done; verifying whether or not the authentication has been done, when it is determined that the request does not present information indicating that the authentication has been done; issuing to the browser the information indicating that the authentication has been done, when it is verified that the authentication has been done; and relaying data communication between the browser and the resource, when it is determined that the request presents the information indicating that the authentication has been done.

### BACKGROUND

1. Technical Field

The present invention relates to a computer readable recording medium storing a control program, a communication system and a computer data signal embedded in a carrier wave.

2. Related Art

There has been proposed an SSO (Single Sign-On) system which allows a user, once authenticated, to utilize all the functions available for authenticated users.

When a network system is operated by a school or a company, the system security is enhanced by providing a proxy server on the border between an internal network and an external network (for example, Internet) so that the proxy server performs connection to the external network on behalf of a computer. This proxy server is used for utilizing a server on the external network from the internal network, and is sometimes particularly referred to as a “forward proxy”.

In contrast to the forward proxy relaying connection from the internal network to the external network, a reverse proxy relays connection from the external network to the internal network. The use of the reverse proxy is not limited to the connection from the external network to the internal network, but the reverse proxy is often used within a single network.

The SSO systems include a reverse proxy type SSO system in which a reverse proxy is arranged to manage and inspect all the connections from the external network. In this type of system, all the requests from Web browsers to a Web server are once received by the reverse proxy, and transferred to the Web server. Therefore, all the requests pass through the reverse proxy, which may cause a bottleneck, leading to decrease in processing speed and usability.

In the reverse proxy type SSO system, all the contents seem to be located in the reverse proxy when viewed from the browser. If a link is set in the contents (made up for example by HTML (Hyper Text Markup Language), a style sheet (CSS), a client-side script language (Java Script (registered trademark), VB Script or the like)), the reverse proxy is required to rewrite the contents every time the linked URL is changed. These contents are mostly created manually by the user or created automatically by a program when accessing to the server. Accordingly, there is no guarantee that the contents are always syntactically correct. Actually, they often contain syntactic errors.

Any error in the syntax will make it difficult to rewrite the contents. Therefore, precautionary measures such as syntax checking are sometimes required on the server side. This is one of the reasons why it is difficult to provide a desired service by means of the conventional SSO system.

In addition to the reverse proxy type SSO system described above, there has also been proposed an agent type SSO system in which an authentication module is incorporated in the Web server so that authentication is performed before a request reaches a Web application. The incorporation of the authentication module in the Web server causes dependence on the platform or type of the Web server. In some cases, huge amount of modification must be taken on the Web server side.

Further, in the case of an SSO system of a type referred to as the “agent-type reverse proxy SSO”, a virtual server is required for each Web server, which increases the number of IP (Internet Protocol) addresses consumed.

### SUMMARY

An aspect of the present invention provides a computer readable recording medium storing a control program causing a computer arranged on a same terminal as a resource to execute a process for authentication performed at the time of accessing to the resource, the process including: determining whether or not a request from a browser to the resource presents information indicating that the authentication has been done; verifying whether or not the authentication has been done, when it is determined that the request does not present information indicating that the authentication has been done; issuing to the browser the information indicating that the authentication has been done, when it is verified that the authentication has been done; and relaying data communication between the browser and the resource, when it is determined that the request presents the information indicating that the authentication has been done.

### BRIEF DESCRIPTION OF THE DRAWINGS

Embodiments of the present invention will be described in detail based on the following figures, wherein:

FIG. 1 is a block diagram showing an example of configuration of a communication system according to the present invention;

FIG. 2 is an explanatory diagram for explaining a part of the functional configuration of the service providing server 20 shown in FIG. 1;

FIG. 3 is a flowchart showing an example of operation of the communication system shown in FIGS. 1 and 2;

FIG. 4 is a sequence diagram illustrating a first operation of the authentication processing of step S103 in FIG. 3;

FIG. 5 is a sequence diagram illustrating a second operation of the authentication processing of step S103 in FIG. 3;

FIG. 6 is a sequence diagram illustrating operation of the authorization processing of step S104 in FIG. 3; and

FIG. 7 is a diagram showing an example of modifications of the communication system according to the present invention.

### DETAILED DESCRIPTION

Embodiments of a computer readable recording medium storing a control program, a communication system and a computer data signal embedded in a carrier wave according to the present invention will be described in detail with reference to the figures.

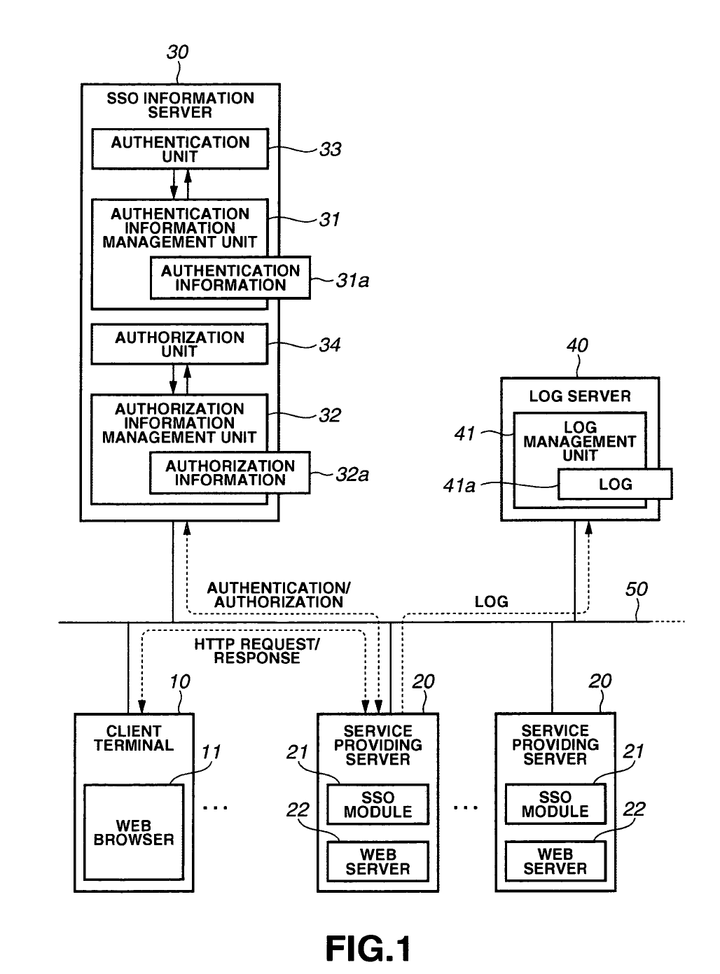

FIG. 1 is a block diagram showing an example of configuration of a communication system according to the present invention.

In this communication system, one or a plurality of client terminals 10, one or a plurality of service providing servers 20, an SSO information server 30, and a log server 40 are connected through a network 50 formed by a LAN (Local Area Network) or WAN (Wide Area Network). In the communication system, the SSO system is executed under the control of an authentication unit 33 of the SSO information server 30 and an SSO module 21 of the service providing server 20. Specifically, the Web browser 11, the SSO module 21, and the authentication unit 33 operate in cooperation so that, once a user is authenticated by the authentication unit 33, the user is afterwards allowed to access any desired service providing server 20 without requirement of authentication. It should be understood that the network configuration of the communication system shown here is only an example, and various other network terminals may be connected on the network 50.

The client terminal 10 has a Web browser 11 as an application for viewing HTML contents and so on. Data communication with the service providing server 20 or the like is executed by using the Web browser 11.

The SSO information server 30 has an authentication information management unit 31 for storing and managing authentication information 31a, and an authorization information management unit 32 for storing and managing authorization information 32a. The SSO information server 30 further has an authentication unit 33 which performs authentication based on the authentication information 31a, and an authorization unit 34 which performs authorization based on the authorization information 32a.

The service providing server 20 has a Web server 22 which holds various information such as HTML contents and images, and resources such as Web applications or the like. The service providing server 20 provides information or the like in response to an HTTP (Hyper Text Transfer Protocol) request (hereafter, sometimes abbreviated to a “request”) that is sent from the client terminal 10 through the Web browser 11.

The Web server 22 does not directly receive the request from the Web browser 11, but always receives the same via the SSO module 21. A response from the Web server 22 to the request is also returned to the Web browser 11 via the SSO module 21. This means that all the data communications between the client terminal 10 and the Web server 22 are performed through the SSO module 21. Since the SSO module 21 and the Web server are arranged in the same server, there is no necessity of rewriting the contents.

The SSO module 21 cooperates with the SSO information server 30 to perform authentication and authorization, and outputs a log indicating the results of the processing to the log server 40. The log output to the log server 40 is stored and managed by a log management unit 41 of the log server 40.

The log server 40 manages all the logs 41a sent from the service providing servers 20, which ensures high usability to users in terms of maintenance and protection as well. Additionally, since the logs are managed separately from the SSO module 21, it is possible to reduce the risk, even if the server having the SSO module 21 is accessed by an unauthorized intruder, that the logs will be deleted or tampered by the intruder to erase the evidence of intrusion. The log server 40 may be provided with a tamper-detection function. A plurality of log servers 40 instead of a single log server may be arranged. In this case, improvement in usability and tamper-resistance can be expected.

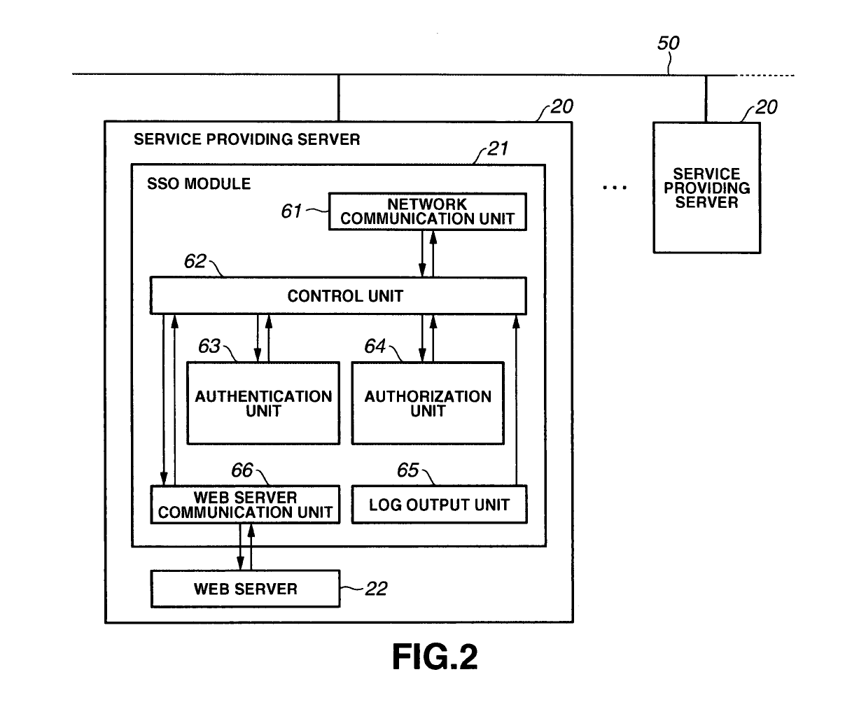

Referring to FIG. 2, a description will be made of a part of the functional configuration of the service providing server 20 shown in FIG. 1

The service providing server 20 is functionally composed of two major components; the SSO module 21 and the Web server 22. The SSO module 21 includes therein various processing units, namely a network communication unit 61, a control unit 62, an authentication unit 63, an authorization unit 64, a log output unit 65, and a Web server communication unit 66.

The network communication unit 61 functions to communicate with terminals on the network 50. Specifically, the network communication unit 61 receives a request to the Web server 22 from the network 50 and relays the same to the Web server 22.

The control unit 62 integrally controls the operation of the SSO module 21. This means that all the functional units forming the SSO module 21 operate according to instructions from the control unit 62. The control unit 62 also controls the input/output of data between the functional units of the SSO module 21.

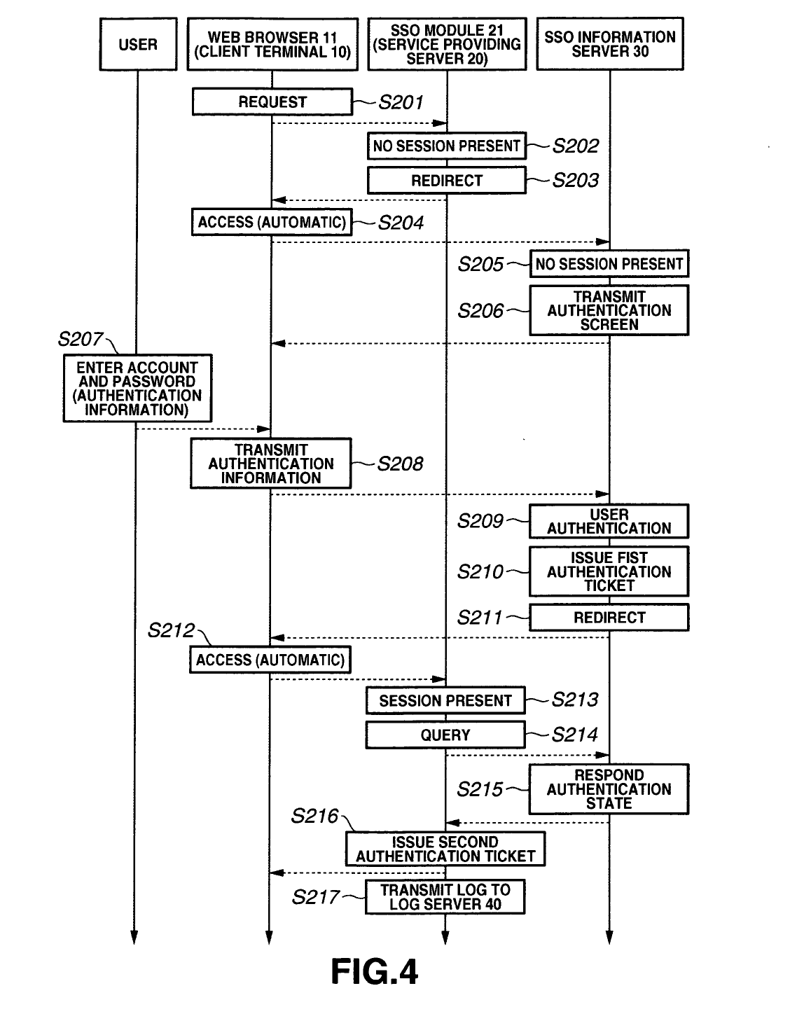

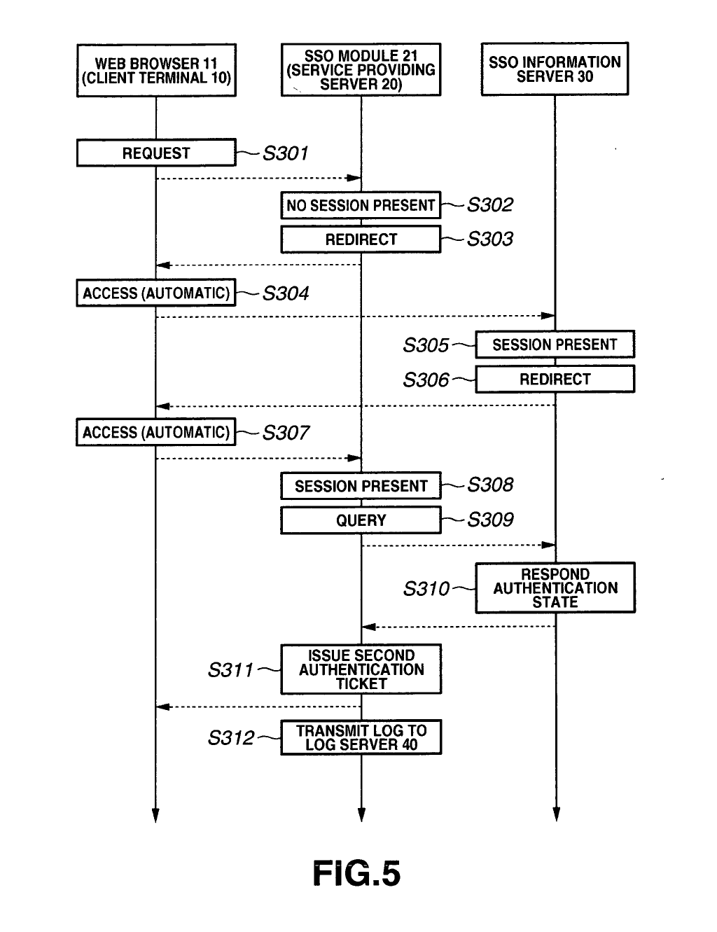

The authentication unit 63 cooperates with the authentication unit 33 of the SSO information server 30 to execute authentication processing. Particulars of the authentication processing by the authentication unit 63 will be described later in detail with reference to FIGS. 4 and 5.

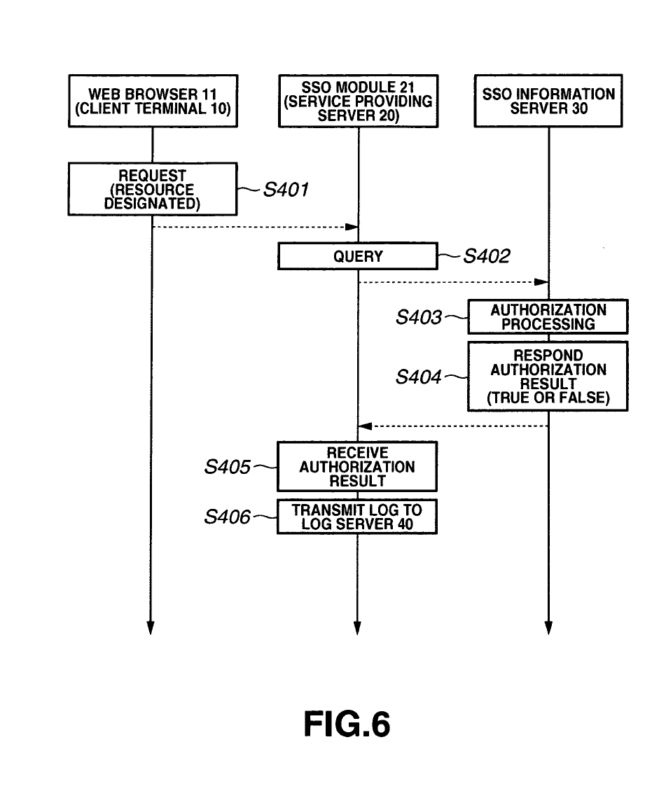

The authorization unit 64 has a function to determine whether or not to authorize the access to a resource designated by an authenticated user. This determination of authorization is performed based on a query to the SSO information server 30. The authorization can be executed by a conventional method. For example, the resource can be identified by referring to a host, a path, or an extension indicated by the request. The authorization result may be cached to prevent the communication with the SSO information server 30 from creating a bottleneck. The authorization processing by the authorization unit 64 will be described later with reference to FIG. 6.

The log output unit 65 has a function to generate and output a log representing the contents of processing performed by the SSO module 21, in particular the authentication and authorization processing. The log output unit 65 may be designed to also generate and output a log relating to data communication with the Web server 22. The logs generated and output by the log output unit 65 are not limited to those relating to authentication and authorization, but may be related to various other items.

The Web server communication unit 66 functions to communicate with the Web server 22. This means that the Web server communication unit 66 transfers a request or the like from the Web browser 11 to the Web server 22. When transferring the request, the Web server communication unit 66 also gives the Web server 22 identification information of the user incorporated in the HTTP request header including a Cookie. A message authenticator or digital signature may be added to the HTTP request header in order to assure that the header is not faked. The Web server 22 can be set so as to accept local requests only and not to accept data communication from any other source than the Web server communication unit 66. In this manner, the risk can be avoided that the Web server 22 will be directly accessed by bypassing the SSO module 21, or the Web server 22 will be accessed by a source other than the SSO module 21 by an IP spoofing attack or the like.

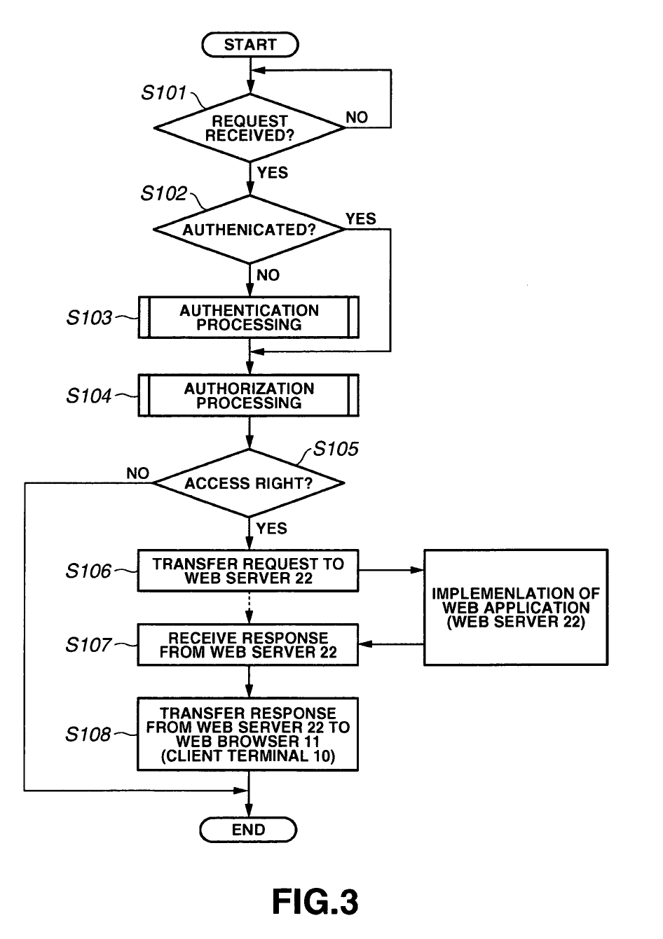

Referring to FIG. 3, a description will now be made of operation of the communication system shown in FIGS. 1 and 2. The description herein will be made of the operation when the service providing server 20 has accepted an HTTP request from the Web browser 11.

The processing is started when the network communication unit 61 of the SSO module 21 has accepted an HTTP request from the Web browser 11 (YES in step S101). Upon start of the processing, the authentication unit 63 determines whether or not the user of the request source has been authenticated before. The determination on whether the user has been authenticated or not can be performed by querying to the SSO information server 30 or by referring to the Cookie.

If it is determined that the user has not been authenticated (NO in step S1102), then authentication processing is executed (step S103). If it is determined that the user has already been authenticated (YES in step S1102), the authorization unit 64 then performs authorization processing to determine whether or not to authorize the user to access the resource (step S104). The authentication processing in step S103 and the authorization processing in step S104 will be described later in detail.

If it is determined, as a result of the authorization processing, that the user has no access right to the resource (NO in step S1105), this processing is terminated for example by informing the user that he/she has no access right. If it is determined that the user has access right (YES in step S105), the Web server communication unit 66 of the SSO module 21 transfers the request from the Web browser 11 to the Web server 22 (step S106).

Upon receiving the transferred request, the Web server 22 executes a Web application or the like in response to the request, and returns the result of the execution to the Web server communication unit 66 (step S107). Receiving the response, the Web server communication unit 66 transfers the response to the network communication unit 61, which further transfers the same to the Web browser 11 (step S108). The processing is thus terminated.

Referring to FIG. 4, a description will be made of the flow of the authentication processing in step S103 of FIG. 3. FIG. 4 is a sequence diagram illustrating an example of the flow of the authentication processing executed by the communication system shown in FIGS. 1 and 2. The description here will be made of the flow of the processing before the user is authenticated.

Upon receiving an HTTP request from the Web browser 11 (step S201), the authentication unit 63 of the SSO module 21 first determines whether or not a session is present between the SSO module 21 and the Web browser 11 that is the request source. Since it is assumed here that this is the first access, there is no session present (step S202). Therefore, the authentication unit 63 instructs the Web browser 11 to redirect to the SSO information server 30 (step S203). At the same time, the Web browser 11 receives the URL of the SSO information server 30 to be redirected to and information containing the URL of the service providing server 20 to be returned.

According to the redirect, the Web browser 11 automatically accesses the SSO information server 30 (step S204). Since this access to the SSO information server 30 is performed automatically by the redirect, the user is not required to perform any particular operation.

Upon receiving the request from the Web browser 11, the SSO information server 30 generates a new session since there is no session present between the SSO information server 30 and the Web browser 11 (step S205), and transmits an authentication screen to the Web browser 11 (step S206). The transmission of the authentication screen is executed by the authentication unit 33. The authentication screen has entry fields for entering authentication information such as account information and a password.

When the authentication screen is displayed on the Web browser 11 and the user enters authentication information on the screen (step S207), the entered authentication information is transmitted from the Web browser 11 to the SSO information server 30 (step S208). The authentication unit 33 of the SSO information server 30 then performs authentication of the user (step S209). The authentication is performed based on the authentication information thus received and authentication information 31a managed by the authentication information management unit 31.

If the authentication determines that the authentication information is invalid, a response indicative of the authentication failure is given to the Web browser 11 so that the user is prompted to retry authentication or to terminate the processing. If the authentication is successful, a first authentication ticket (Cookie) for the SSO information server 30 is issued to the Web browser 11 (step S210). This first authentication ticket can be presented only to the SSO information server 30, and is not valid for using the SSO module 21.

In this response, the URL of the service providing server 20 is indicated and the redirect to the service providing server 20 is instructed (step S211). This is because the user originally intended to access the service providing server 20.

This redirect causes the Web browser 11 to automatically access the service providing server 20 (step S212). The authentication unit 63 of the SSO module 21 determines whether or not a session is present between the SSO module 21 and the Web browser 11 that is the request source. Since there is a session due to the access in step S201 in this case, it is determined that a session is present (step S213).

If a session is present, the authentication unit 63 makes a query to the authentication unit 33 of the SSO information server 30 about the authentication state of the user (step S214). If the response to the query is that the user has been authenticated (step S215), the authentication unit 63 receiving the response issues to the Web browser 11 a second authentication ticket that is valid only for the SSO module 21 (step S216). The authentication to the SSO module 21 is thus completed. Upon second and subsequent accesses, the Web browser 11 has only to present this second authentication ticket and is not necessarily to be authenticated again.

Once the authentication processing has been completed, the log output unit 65 of the SSO module 21 transmits to the log server 40 a log indicating the result of the authentication processing performed by the SSO module 21 as described above (step S217). Although, in FIG. 4, the log is transmitted to the log server 40 upon completion of the authentication processing, the log may be transmitted at any time during the authentication processing.

Referring to FIG. 5, a description will be made of the flow of the authentication processing in step S103 of FIG. 3. FIG. 5 is a sequence diagram illustrating an example of the flow of the authentication processing executed by the communication system shown in FIGS. 1 and 2. The sequences shown in FIG. 5 is different from the sequence in FIG. 4 in that a session is present between the Web browser 11 and the SSO information server 30 in FIG. 5 while not in FIG. 4 (step S205 in FIG. 4 and step S305 in FIG. 5). This means that FIG. 5 illustrates the flow of processing when the user, who has been authenticated (the user has used a service providing server 20), accesses another service providing server 20 having no session.

Upon receiving an HTTP request from the Web browser 11 (step S301), the authentication unit 63 of the SSO module 21 first determines whether or not a session is present between the SSO module 21 and the Web browser 11 that is the request source. Since this is the first access to the SSO module 21, there is not session (step S302). Therefore, the authentication unit 63 instructs the Web browser 11 to redirect to the SSO information server 30 (step S303). At the same time, the Web browser 11 receives the URL of the SSO information server 30 to be redirected to and information containing the URL of the service providing server 20 to be returned.

According to the redirect, the Web browser 11 automatically accesses the SSO information server 30 (step S304). Since this access to the SSO information server 30 is performed automatically by the redirect, the user is not required to perform any particular operation.

Since there is a session between the Web browser 11 and the SSO information server 30 (step S305), and the user has already been authenticated, the first authentication ticket is presented by the Web browser 11 to the SSO information server 30. By the first authentication ticket being presented by the Web browser 11, the SSO information server 30 is allowed to recognize that the user has been authenticated and no further authentication of the user is required. The SSO information server 30 instructs the Web browser 11 to redirect to the service providing server 20 (step S306).

According to the redirect, the Web browser 11 automatically accesses the service providing server 20 (step S307). The authentication unit 63 of the SSO module 21 determines whether or not a session is present between the SSO module 21 and the Web browser 11 that is the request source. Since there is a session due to the access in step S301, it is determined that there is a session (step S308).

If there is a session, the authentication unit 63 makes a query to the authentication unit 33 of the SSO information server 30 about the authentication state of the user (step S309). If the response to the query is that the user has been authenticated (step S310), the authentication unit 63 receiving the response issues to the Web browser 11 a second authentication ticket that is valid only for the SSO module 21 (step S311). The authentication to the SSO module 21 is thus completed. Upon second and subsequent accesses, the Web browser 11 has only to present this second authentication ticket and is not necessarily to be authenticated again.

Once the authentication processing has been completed, the log output unit 65 of the SSO module 21 transmits to the log server 40 a log indicating the result of the authentication processing performed by the SSO module 21 as described above (step S312). Although, in FIG. 5, the log is transmitted to the log server 40 upon completion of the authentication processing, the log may be transmitted at any time during the authentication processing.

Referring to FIG. 6, a description will be made of the flow of the authorization processing in step S104 of FIG. 3. FIG. 6 is a sequence diagram illustrating an example of the flow of the authorization processing executed by the communication system shown in FIGS. 1 and 2.

Upon receiving an HTTP request designating a resource from the Web browser 11 (step S401), the authorization unit 64 of the SSO module 21 determines whether or not to authorize the user to access the resource. For this purpose, the authorization unit 64 first makes a query to the authorization unit 34 of the SSO information server 30 about the user's access right (step S402). At the same time, the SSO information server 30 receives information containing user identification information and resource specifying information.

The authorization unit 34 of the SSO information server 30 performs authorization processing based on the information thus received (step S403). Specifically, the authorization unit 34 determines whether or not to authorize the user to access the resource, based on the user identification information and resource specifying information thus received and the authorization information 32a managed by the authorization information management unit 32.

If this authorization processing determines that the user has no access right, FALSE is returned from the SSO information server 30 to the SSO module 21, whereas if it is determined that the user has access right, TRUE is returned (step S404). Upon receiving this, the authorization unit 64 does or does not authorize the user to access the resource based on the result of determination (step S405).

Upon completion of the authorization processing, the log output unit 65 of the SSO module 21 transmits to the log server 40 a log indicating the result of the authorization processing executed by the SSO module 21 described above (step S406). Although, in FIG. 6, the log is transmitted to the log server 40 upon completion of the authentication processing, the log may be transmitted at any time during the authentication processing.

While the present invention has been described and illustrated in its preferred embodiment as a representative example thereof, it is to be understood that the present invention is not limited thereto but may be otherwise variously embodied within the scope of the invention.

For example, when using form authentication, the authentication unit 33 of the SSO information server 30 is not used and the SSO module 21 fills account information and a password in the page for form authentication. Since the SSO module 21 and the Web server 22 are connected by local communication at this time, no security problem will arise even if sensitive data such as a password is communicated in plaintext.

When there is a Web application not using SSL (Secure Socket Layer), communication in SSL can be realized by using HTTPS (Hypertext Transfer Protocol Security) for data communication between the client terminal 10 and the SSO module 21 while still using HTTP for data communication with the Web application. However, this is based on the premise that the contents paths under the control of the Web server itself are written in relative paths so that rewriting of the URL scheme (the part before the colon) is not necessary.

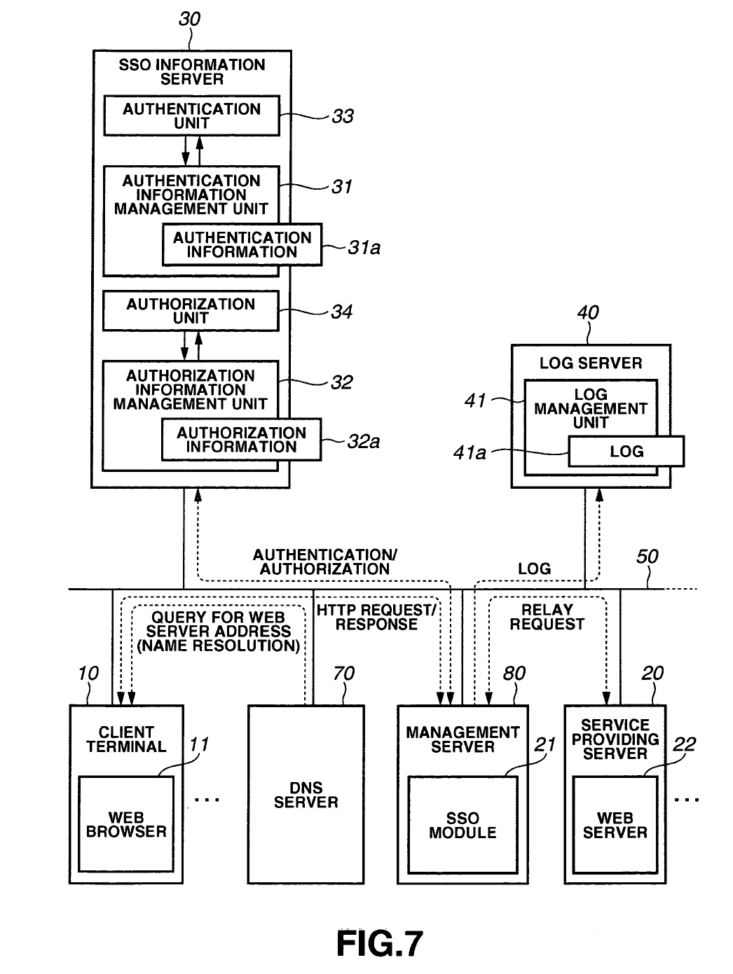

The SSO module 21 and the Web server 22 may be arranged in separate machines. This can be realized by combining with the setting of a DNS (Domain Name System). For example, as shown in FIG. 7, a DNS server 70 may be arranged so that the name of the Web server 22 to be accessed is resolved by a machine in which the SSO module 21 is arranged (management server 80), whereby the rewriting of the contents can be avoided. Further, a plurality of SSO modules 21 may be arranged depending on the setting of the DNS (for example, a SSO module 21 may be arranged in each subnet). In this case, the bottleneck in performance can be avoided.

Even a protocol other than HTTP having no authentication function can be handled by using SSL as the transport layer to perform mutual authentication.

The communication system may be combined with an IDS (Intrusion Detection System) or IPS (Intrusion Prevention System) to improve the security.

The user authentication may be executed by the authentication unit 63 of the SSO module 21. In other words, the function of the authentication unit 33 of the SSO information server 30 described above may be assigned to the authentication unit 63 of the SSO module 21. In this case, it is desirable that the authentication information 31a is stored and managed by the SSO information server 30, in the same manner as in the embodiment described above, and the authentication is performed based on a query from the SSO information server 30. It is obvious, however, that the authentication information 31a may be arranged on the same terminal as the SSO module 21. Further, the authorization unit 64 also may be configured in the same manner as the authentication unit 63.

Although the description of the embodiment above has been made in terms of an example where the SSO module 21 is provided with the authentication unit 63 and the authorization unit 64 so as to execute both authentication and authorization, the authorization is not necessarily executed by the SSO module 21 or may be not executed at all. The authorization, if executed, may be set for a Web application as a whole instead of for each content.

Although the description of the embodiment above has been made in terms of an example where the SSO module 21 is provided with the log output unit 65 to output a log indicating the result of the processing, the log need not necessarily be output and may be not output at all.

Although the description of the embodiment above has been made in terms of a case where processing is executed by the communication system according to the present invention, the processing may be executed by a control program installed in a computer. The control program can be provided not only by communication media such as a network but also by storing the same in a recording medium such as a CD-ROM.

The control program and the communication system according to the present invention are applicable to all the control programs and communication systems which are designed to have a computer to execute authentication processing for a resource.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

What is claimed is:

1. A computer readable recording medium storing a control program causing a computer arranged on a same terminal as a resource to execute a process for authentication performed at the time of accessing to the resource, the process comprising:
determining whether or not a request from a browser to the resource presents information indicating that the authentication has been done;
verifying whether or not the authentication has been done, when it is determined that the request does not present information indicating that the authentication has been done;
issuing to the browser the information indicating that the authentication has been done, when it is verified that the authentication has been done; and
relaying data communication between the browser and the resource, when it is determined that the request presents the information indicating that the authentication has been done.

2. The computer readable recording medium storing the control program according to claim 1, wherein whether or not the authentication has been done is verified based on a query to a specific terminal connected via a communication unit.

3. The computer readable recording medium storing the control program according to claim 2, wherein when it is not verified that the authentication has been done, the request from the browser is redirected to the specific terminal to execute authentication.

4. The computer readable recording medium storing the control program according to claim 1, the process further comprising authorizing an access to the resource prior to the data communication.

5. The computer readable recording medium storing the control program according to claim 4, wherein the authorizing is performed based on a query to a specific terminal connected via a communication unit.

6. The computer readable recording medium storing the control program according to claim 1, the process further comprising outputting a log to another terminal.

7. A computer readable recording medium storing a control program causing a computer to execute a process for authentication performed at the time of accessing to a resource, the process comprising:
determining whether or not a request from a browser to the resource presents information indicating that the authentication has been done;
verifying whether or not the authentication has been done, when it is determined that the request does not present information indicating that the authentication has been done;
issuing to the browser the information indicating that the authentication has been done, when it is verified that the authentication has been done; and
relaying data communication between the browser and the resource via a name server, when it is determined that the request presents the information indicating that the authentication has been done.

8. A communication system having a first terminal and a second terminal connected to each other via a communication unit, wherein:
the first terminal comprises:
an authentication unit that performs authentication based on authentication information; and
a first authorization unit that authorizes access to a resource based on the authorization information, and
the second terminal comprises:
a storage that stores the resource;
a determination unit that determines whether or not a request from a browser to the resource presents information indicating that the authentication has been done;
a verification unit that verifies whether or not the authentication has been done, when the determination unit determines that no information indicating that the authentication has been done is presented;
an issuing unit that issues, to the browser, the information indicating that the authentication has been done, when the verification unit verifies that the authentication has been done;
a second authorization unit that authorizes access to the resource based on a query to the first authorization unit, when the information indicating that the authentication has been done is presented; and
a relay unit that relays data communication between the browser and the resource when the information indicating that the authentication has been done is presented.

9. A computer data signal embedded in a carrier wave for enabling a computer arranged on a same terminal as a resource to execute a process for authentication performed at the time of accessing to the resource, the process comprising:
determining whether or not a request from a browser to the resource presents information indicating that the authentication has been done;
verifying whether or not the authentication has been done, when it is determined that the request does not present information indicating that the authentication has been done;
issuing to the browser the information indicating that the authentication has been done, when it is verified that the authentication has been done; and
relaying data communication between the browser and the resource, when it is determined that the request presents the information indicating that the authentication has been done.
